(19) United States
(12) Patent Application Publication
(10) Pub. No.: US 2025/0058215 A1
(43) Pub. Date: Feb. 20, 2025

(54) PROGRAM, INFORMATION PROCESSING APPARATUS, MATCH-MAKING SERVER, AND MATCH-MAKING SYSTEM

(71) Applicant: BANDAI CO., LTD., Tokyo (JP)

(72) Inventors: Yusaku KUBOTA, Tokyo (JP); Tatsuya MORIMOTO, Tokyo (JP); Yushiro UEHARA, Tokyo (JP); Issei HOSODA, Tokyo (JP)

(21) Appl. No.: 18/806,762

(22) Filed: Aug. 16, 2024

(30) Foreign Application Priority Data
Aug. 18, 2023 (JP) 2023-133642

(51) Int. Cl. A63F 13/48; A63F 13/825

(52) U.S. Cl. CPC A63F 13/48; A63F 13/825

(57) ABSTRACT

A virtual character associated with a user is placed so as to be movable is displayed and process is performed in response to a request from the user according to the virtual space including first and second virtual space in which the virtual character of the user is placed. Process is performed to accept a selection of a game title from two or more game titles by the user when the virtual character is placed in the first virtual space, process related to preparation for play of a game of the game title is performed when the virtual character is placed in the second virtual space, the virtual character placed in the first virtual space is arranged in the second virtual space, on condition that the selection of a game title is accepted, and the process related to preparation for play includes match-making an opponent for the game.

### CROSS-REFERENCE TO RELATED APPLICATIONS

The disclosure of Japanese Patent Application No. 2023-133642 filed on Aug. 18, 2023 including specification, drawings and claims is incorporated herein by reference in its entirety.

### TECHNICAL FIELD

The present invention relates to a program, an information processing apparatus, a match-making server, and a match-making system.

### BACKGROUND

There exists a match-making system which match-makes players for a battle game executed on an outside service via a virtual space (for example, Japanese Patent Application Publication No. 2022-078744). In such a match-making system, users are managed by distributing them across multiple rooms in order to achieve smooth communications and reduce the information processing load on the server. In the matching system disclosed in Japanese Patent Application Publication No. 2022-078744, a virtual space consisting of multiple rooms is provided, allowing users to select one room from a list of rooms at the start of the service. In the selected virtual space, users can utilize functions for match-making and spectating battle games in the outside service.

### PRIOR ART

### Patent Documents

[Patent Document 1] Japanese Patent Application Publication No. 2022-078744

### SUMMARY

### Technical Problem

However, the match-making system disclosed in Japanese Patent Application Publication No. 2022-078744 requires users to check room occupancy rates and select a room from the list to enter it, which involves operational inputs from the user.

The objective of the present invention is to provide a program, an information processing device, a match-making server, and a match-making system, which offer an improved match-making service with improved usability.

### Solution to Problem

An aspect of the present invention is a program that causes a computer to execute display control processing and control processing. In the display control processing, a virtual space where a virtual character corresponding to the user can move is displayed. The control processing executes tasks in response to user requests according to the virtual space in which the user's virtual character is placed. The virtual space includes a first virtual space and a second virtual space. In the control processing, when the user's virtual character is placed in the first virtual space, processing is executed to accept a selection of a game title to play from multiple game titles. When the user's virtual character is located in the second virtual space, it executes processing related to the preparation for playing the selected game title. In the display control processing, conditioned upon the acceptance of the game title selection, the user's virtual character is placed and displayed in the second virtual space. The processing related to play preparation includes at least the process of match-making opponents for the game title to be played.

### Advantageous Effect of Invention

According to the present invention, it is possible to provide a match-making service with improved usability.

### BRIEF DESCRIPTION OF DRAWINGS

FIG. 1 illustrates the configuration of a match-making system according to an embodiment of the present invention and modifications thereof;

FIG. 2 illustrates a hardware configuration of a user terminal 100 according to the embodiment of the present invention and modifications thereof;

FIG. 3 illustrates the hardware configuration of a server 200 according to the embodiment of the present invention and modifications thereof; FIG. 2 illustrates a hardware configuration of a user terminal 100 according to the embodiment of the present invention and modifications thereof;

FIG. 4 illustrates an avatar used in the match-making service according to the embodiment of the present invention and modifications thereof; FIG. 4 illustrates an avatar used in the match-making service according to the embodiment of the present invention and modifications thereof;

FIG. 5 illustrates a battle room of the match-making service according to the embodiment of the present invention and modifications thereof;

FIGS. 6A and 6B are diagrams for explaining a match-making function in the battle room according to the embodiment and modifications of the present invention;

FIGS. 7A and 7B respectively illustrate a play screen of a battle game according to the embodiment of the present invention and modification thereof;

FIGS. 8A-8E respectively show an example of various types of information managed in the match-making service according to the embodiment of the present invention and modifications thereof;

FIG. 9 illustrates an example of an entrance room of the match-making service according to the embodiment of the present invention and modifications thereof;

FIG. 10 shows a user interface according to the embodiments and modifications of the present invention, which is displayed when a battle room, which is a transition destination, is selected;

FIG. 11 illustrates display of avatars in a friend relationship in the entrance room according to the embodiment of the present invention and modifications thereof;

FIG. 12 illustrates display of a notification regarding an event period in the match-making service according to the embodiments of the present invention and modifications thereof;

FIG. 13 is a flowchart illustrating switching processing executed by the server 200 according to the embodiments of the present invention and modifications; and

FIG. 14 is a flowchart illustrating the event period processing executed by the server 200 according to the embodiments of the present invention and modifications thereof.

### DETAILED DESCRIPTION

### Embodiment 1

Embodiments will be explained in detail referring to figures. The embodiments does not limit the scope of the invention. In addition, combinations of structures described below as embodiments, are not necessarily indispensable to the present invention. Any two or more features described as the embodiments can be arbitrarily combined. In addition, the same reference numbers are assigned to similar structures or the same structures and duplicate explanation thereof will be omitted.

The embodiment is described below as one example of a match-making system, wherein the present invention is applied to a system, in which a server accepts connection from an information processing apparatus (a user terminal) used by a user, provides a service for realizing a match-making for a two player game (such as a one-to-one match game, a versus game, battle game, competition game, one-to-one match, fighting game and the like) provided in an outside service via a virtual space. However, the present invention can also be applied to a system realized by any device configuration which can perform match-making for a game involving three or more users via such a virtual space, and which can trigger execution of the game.

In this specification, the term ‘user’ refers to one who utilizes the service (match-making service) provided by a server 200 within a match-making system. For convenience, a user, for whom the match-making has been established in the virtual space and who is playing the game, may be referred to as a ‘player’.

### <<Configuration of the Match-Making System>>

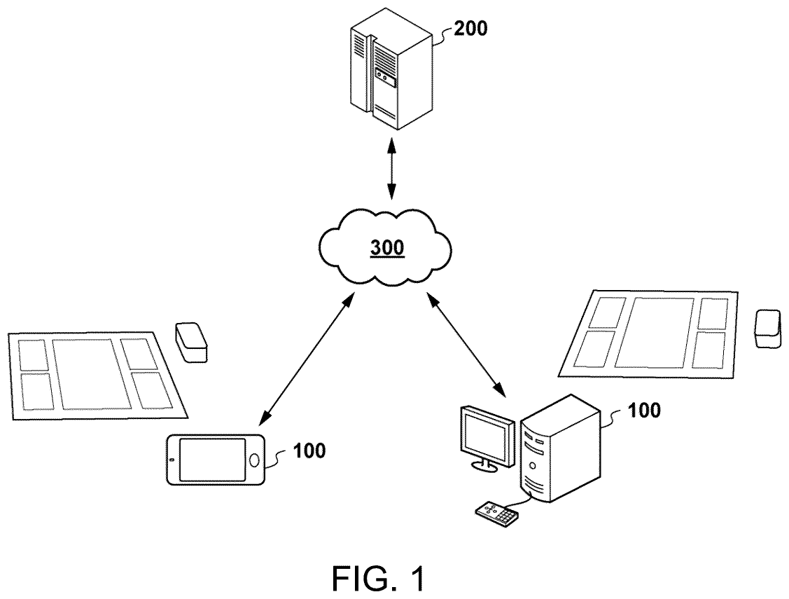

FIG. 1 illustrates the configuration of a match-making system according to the present embodiment. As shown in the figure, the match-making system is configured such that the server 200 can communicate with multiple user terminals 100 through a network 300. The server 200 according to the embodiment, provides the match-making service, in which the match-making system performs match-making for the users of connected user terminals 100 as players of a battle game, which is realized by the outside service, thereby triggering the execution of a battle game.

In the explanation set forth below, the outside service is described as a service for supporting execution of a play of the battle game between or among remote players. The service does not have a free match-making type function for picking up the required number of players for the service provision. In the outside service according to the embodiments, when the required number of players access a room (connection destination) created by a host player using their user terminals 100, a video chat function utilizing a camera and a microphone of each of the user terminals 100 becomes available, thereby realizing the game play of a trading card game (TCG) progressing while sharing the status of game items therefor, which are developed in the real-world environment where the players exist. Therefore, each of the user terminals 100 can be a personal computer or a smartphone equipped with a camera and a microphone.

Details will be described later, but users of the match-making service can use the service by logging in using the user terminal 100, wherein in the service a virtual space where the avatar (operable avatar) associated with the user is arranged can be displayed. The match-making service is a web service accessible via a browsing application (hereinafter simply referred to as ‘browser’), and in the service, a login is performed by completing the user authentication process on a specific web page. The users can move the operable avatar arranged in the virtual space by performing various operation inputs, communicate with other users through the avatar (by text chat etc.), and can be matched with an opponent for a battle game provided by the outside service.

### <Hardware Configuration of User Terminal>

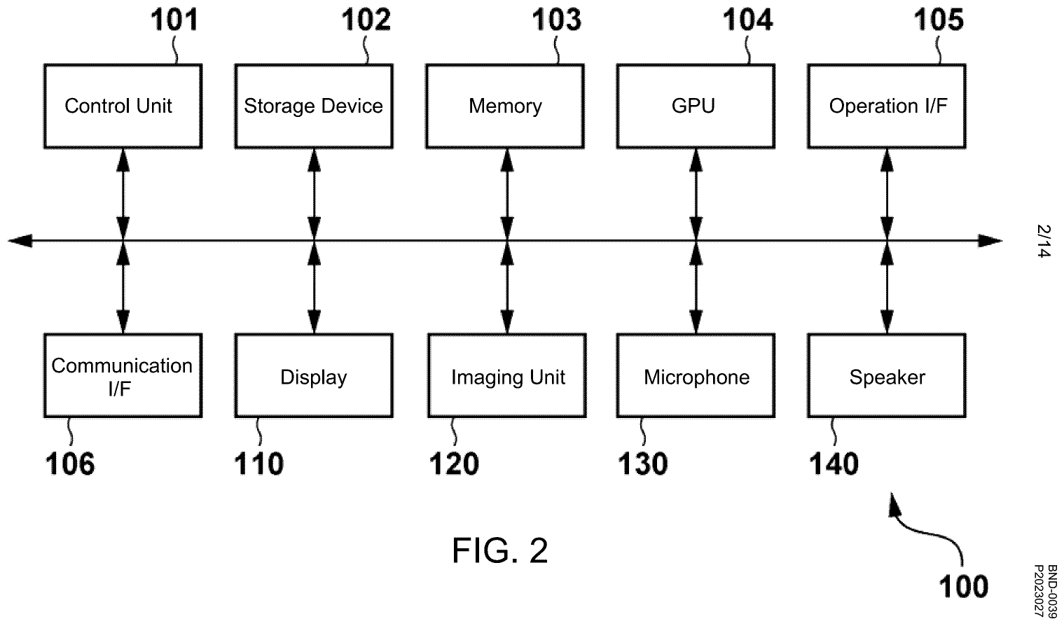

Next, the hardware configuration of the user terminal 100 will be described with reference to FIG. 2. FIG. 2 is a block diagram illustrating the hardware configuration of the user terminal 100.

The control unit 101, which is a processor such as a CPU, performs various controls including operation control of the hardware provided in the user terminal 100. Specifically, the control unit 101 reads the necessary programs stored in a storage device 102, deploys them in a memory 103, and executes them to perform the corresponding control.

The storage device 102 is a device capable of permanently storing information, such as a non-volatile memory or HDD. The storage device 102 stores programs the operating system required for the operation of user terminal 100 and various application-related programs, in addition to information on parameters necessary for realizing various controls, and various data used for display and communication functions related to the browser. The memory 103 is a storage device used for a temporary data storage, such as a volatile memory. The memory 103 may be used not only as a deployment area for each program but also as a storage area for temporarily storing data output during operations of various hardware and the process of various controls.

The GPU 104 is an image drawing device which performs various drawing processes related to generation of display screens for the user terminal 100. The GPU 104 also performs drawing processes for screens related to the virtual space, which is presented in the browser during the use of the match-making service. The GPU 104 includes a GPU memory (not shown) and deploys various graphics data read from the storage device 102, performs predetermined calculations to generate various images including the screens. The screens and images generated by the GPU 104 are displayed on a display 110 provided in the user terminal 100, thereby being presented to the user. The display 110 which displays information may be a liquid crystal display or the like, and is provided in the user terminal 100 or may be a device detachable from the user terminal 100. The display 110 displays the screens generated by the GPU 104.

An operation interface 105 is provided in the user terminal 100, and is a user interface for receiving operation inputs. When the operation interface 105 detects that an operation input has been made, it outputs a control signal corresponding to the operation input to the control unit 101. In one embodiment, the operation interface 105 may include operation components such as buttons provided on the exterior of the user terminal 100 and various sensors. Additionally, the display 110 provided in the user terminal 100 is configured to detect a touch input, and the operation interface 105 includes a touch input detection sensor provided on the display 110.

The communication interface 106 is provided in the user terminal 100 and is an interface for communicating with external devices. The information communication between the communication interface 106 and the external devices can be carried out via a wide-area network (WAN) such as the internet or through a local area network (LAN). Although the information communication handled by the communication interface 106 is wirelessly performed, it is not limited thereto, and may be performed by wired communication.

An imaging unit 120 includes an imaging device having an imaging element such as a CCD or CMOS sensor. As detailed later, during the execution of a battle game related to the outside service, the imaging unit 120 intermittently captures images of game cards placed in the imaging range by the user and outputs these captured images.

The microphone 130 is an audio input interface provided in the user terminal 100. In this embodiment, since the battle game related to the outside service triggered by the match-making service is a card trading game (TCG), the microphone 130 acquires sounds related to declarations of players and the reading aloud of the effects of a game card. Additionally, the speaker 140 is an audio output interface provided in the user terminal 100. The speaker 140 outputs sounds related to the match-making service and audio related to the battle game (such as declarations by the opposing player or sound effects).

[symbol]

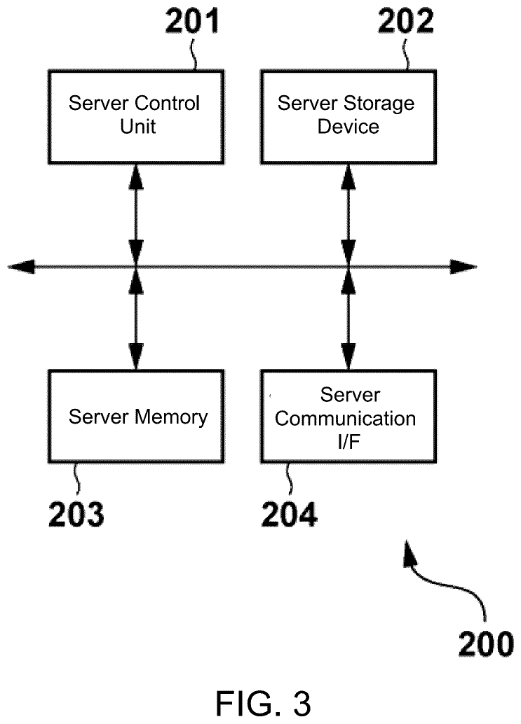

Server Hardware Configuration [symbol]
FIG. 3 shows a block diagram of a hardware configuration of the server 200 according to the present embodiment. In the following description, to distinguish a hardware structure of the server 200, which achieves the same functions as that of the user terminal 100, from that of the user terminal 100, the prefix “server” is added to the components related to the server.

The server control unit 201 is a processor, such as a CPU, which performs control relating to realization of various functions including an operation control of each hardware provided in the server 200, a user management relating to a match-making service, and a match-making function for users. Specifically, the server control unit 201 reads necessary programs stored in the server storage device 202, expanding them in the server memory 203, and executes them to perform the corresponding control.

The server storage device 202 is a device capable of permanently storing information, such as non-volatile memory, an HDD and the like. The server storage device 202 stores programs related to the operating system necessary to operate the server 200, programs related to match-making, in addition to information of parameters required to realize various controls, and various data required for match-making functions. Additionally, the server storage device 202 includes a database function to manage the information of each player registered as a user of the match-making system. The server memory 203 is a storage device used for temporarily storing data, such as volatile memory. The server memory 202 is used not only as a deployment area for each program but also as a temporary storage area for data output during the operation of the various hardware and various control processes.

The server communication interface 204 is an interface for communicating with external devices, and is provided in the server 200. Information communication between the server communication interface 204 and the external devices can be conducted via a wide-area network (WAN) such as the internet etc. or through a local area network (LAN). The information communication handled by the server communication interface 204 can be conducted either wirelessly or through wired connections.

[symbol]

Overview of the Match-Making Service [symbol]
Below, the overview of the match-making service provided by the match-making system in this embodiment will be described with reference to the drawings.

As described above, the match-making service becomes available when a user, using the user terminal 100, launches a browser to access the web page (service site) related to the service and logs into the service.

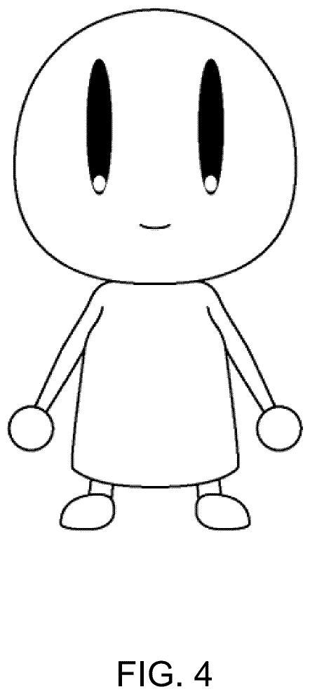

After the service login, a virtual space represented in 3D computer graphics, is displayed as a service screen on each user terminal 100. The service screen is a drawn image of the virtual space, and the number of pixels is set according to the area where the web page of the browser is displayed. In the virtual space, a humanoid 3D model such as an avatar having a head, torso, arms and legs as shown in FIG. 4 (hereinafter referred to as an operable avatar) is assigned to each user. Each user can move the operable avatar assigned to him or her, within the virtual space by performing an operation input(s) related to the movement. In this embodiment, the virtual space is configured as a room-like 3D space, and hereafter, the virtual space may be referred to as “a room” sometimes. Accordingly, the operable avatar moves within the room based on a user's operation input. The room is configured as a space with a certain level of expanse.

In the match-making service according to the embodiment of the present invention, two or more types of virtual spaces are provided, and each user can navigate between these virtual spaces depending on the intended use of the service. That is, the operable avatars of the users are managed by the server 200 such that each of them is placed in only one virtual space at a time.

The virtual space used in the match-making service includes two types: an entrance room and a battle room. The two types of virtual spaces (rooms) have different purposes, and the process(es), which can be executed as a function(s) of the match-making service based on a request(s) from the user, depends on which the virtual space the operable avatar is placed. In other words, the functions of the match-making service available to the user change according to whether the operable avatar is placed in the entrance room or the battle room. When the user login the service, the operable avatar is controlled to be placed in only one room, and it is not placed in multiple rooms simultaneously. Movement (transfer) between rooms is basically achieved when an operation input related to the movement is made in each room, and the corresponding request is sent from the user terminal 100 to the server 200, where the information managed about the operable avatar is updated.

Among the two (or more) types of rooms, the battle room is the virtual space where a function of the match-making (match-making function) is actually provided to match-make a user with an opponent for the battle game the user wants to play. When the match-making is established in the battle room, the execution of the battle game is triggered. On the other hand, the entrance room fundamentally does not provide with the function for match-making a user with an opponent, but provides a user with an auxiliary function(s) (hereinafter referred to as an auxiliary function) such as configuring an operable avatar and selecting a battle room for moving the operable avatar. Thus, in the entrance room, the match-making cannot be established, and the execution of the battle game is not triggered. The features of each of the rooms will be explained in more detail below. In the following explanation, the state where the operable avatar assigned to a user is placed in the 3D space related to either of the rooms may be referred to as the user of the operable avatar “entering the room”.

[symbol]

Entrance Room [symbol]
As described above, the entrance room is a virtual room where the auxiliary function(s) is provided to allow each user to utilize the battle room. In addition, the entrance room is provided for each operable avatar, and, for example, the entrance room is associated with an avatar ID which uniquely identifies the operable avatar. In other words, the entrance room is a virtual room, which is uniquely provided for each operable avatar.

When a user logs into the service site, the operable avatar of the user is first placed in the entrance room provided for that operable avatar, and is displayed. The user can perform an operational input for use of the various auxiliary functions by, for example, moving the operable avatar within the entrance room.

### (Appearance Customization Function)

An appearance customization function is included as an auxiliary function available in the entrance room, by which the appearance of the operable avatar can be changed. The user can change drawing elements which forms its appearance of the avatar, such as the color of the avatar or items attached to the head, body, etc. can be changed differently. Within the entrance room, the user can change the appearance of the operable avatar by selecting items to be attached, from a list of items the user owns.

### (Transfer Function)

The auxiliary functions also include a transfer function for selecting a battle room according to the user's transfer request and for transferring the operable avatar of the user to the selected battle room.

As will be described in detail later, in the match-making service according to the present embodiment, the operable avatars respectively associated with users who desire match-making with opponents are placed in the battle room at that same period, and this appearance is displayed on the display 110 of the user terminal 100 of each user as a service screen (a screen related to the match-making service presented to the user through a browser). To generate the service screen showing the state of the match-making room, information indicating the state of other avatars placed in the match-making room (for example, whether they are in the process of matching-making, and/or what their appearance is, etc.) is required. This information is associated with the battle room in the server 200 and managed therein, and when the user's operable avatar is placed in the battle room, the information is shared by the user terminals 100 and used to generate the service screen.

Therefore, the more avatars placed in the battle room, the greater the amount of information to be referenced when generating the service screen, which may increase the computational load in the user terminal 100. Hence, in the match-making system according to the present embodiment, an upper limit regarding the number of operable avatars that can be placed in the room (the maximum number of users who can enter) is set for each battle room. On the other hand, multiple battle rooms are prepared so that the number of users who can use the match-making function at the same period is secured. The transfer function is performed by the server control unit 201 so that a battle room is selected based on the user's request from among these multiple battle rooms provided in parallel, and the operable avatar associated therewith is transferred.

In the match-making system according to the present embodiment, to enable the service for match-making users with opponents for multiple titles of battle games (Trading Card Games, TCG) or battle games, each title is associated with a designated battle room. Specifically, each battle room is linked to one of the titles, thereby match-making users who wish to play the battle game with that particular title. In other words, in the match-making system, all the users whose avatars are placed in the same battle room, desire match-making for the game title associated with that battle room.

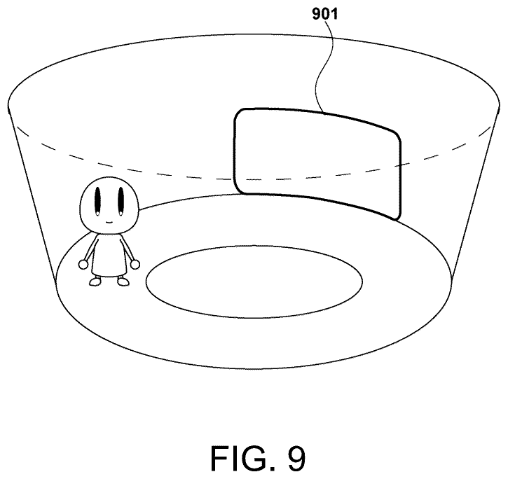

In this way, each user selects the game title which he or she wants to play when requesting to transfer his or her avatar to the battle room. In the match-making system according to the embodiment, the entrance room is provided as an enclosed space, as shown in FIG. 9. The user can select the game title to play by moving his or her operable avatar to a predetermined position within the space. The following describes an example where, by moving the operable avatar near the window section 901 provided in the entrance room, the user interface for selecting the game title to play is presented to the user.

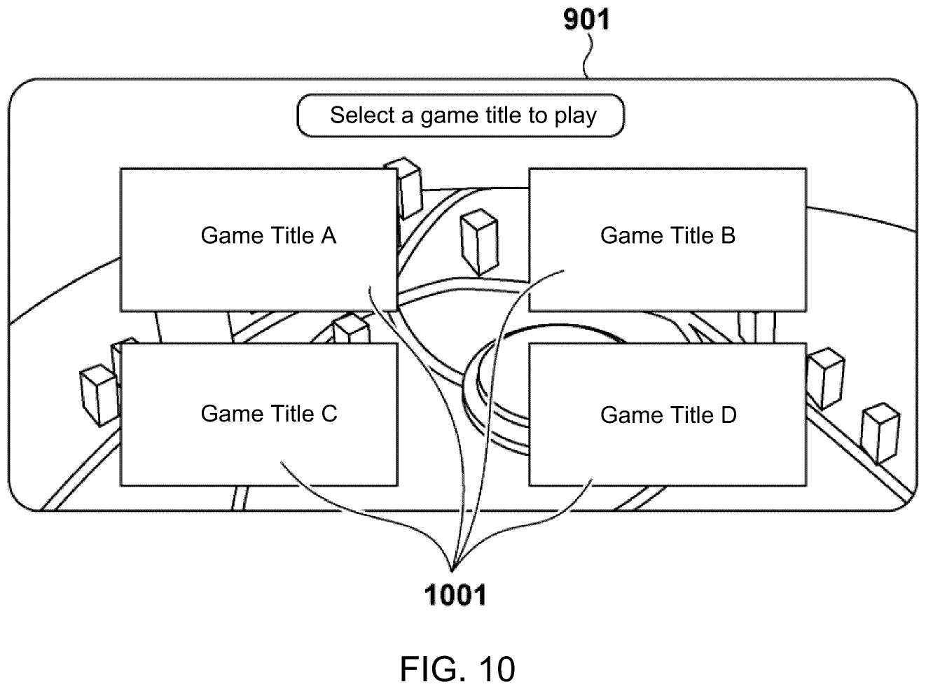

The user interface for selecting a game title in the window section 901 is controlled based on a distance between the operable avatar and the window section 901. For example, a control is performed so that the interface for selecting the game title is displayed in the window section 901 when the distance between the operable avatar and the window is lower than a threshold value. When the distance is longer than the threshold level, the interface is not displayed in the window section 901. In addition, as shown in FIG. 10, when the distance is higher than the threshold level, as the interface for selecting the game title, the window section 901 is enlarged and displayed on the service screen, and further an icon 1001 of each game title is arranged as a list in a region in the window section 901. The user selects the game title to play by selecting an icon 1001 associated with one of game titles displayed on the display 110 of the user terminal 100.

The user can send, to the server 200, a request for transferring the operable avatar to the battle room associated with the game play title by performing an input operation for the game title to play. The server 200 determines which battle room to transfer (arrange) the operable avatar of the user to, according to the transfer request. The battle room determined to arrange the operable avatar is a battle room associated with the game title selected by the user. The server control unit 201 performs processing for moving the operable avatar to the determined battle room.

In addition, as described above, since the upper limit of the avatars to be placeable in each battle room is set, when the game title to play is selected, the icons 1001 of the game title(s) associated with a battle rom(s) where the number of avatars reaches the upper limit may be displayed in a non-selectable state.

(Visit function) Further, the auxiliary functions also include a visit function which allows the user to visit an entrance room provided for an avatar of another user. For example, the user can use the visit function by selecting, from a menu which can be displayed when the operable avatar is in an entrance room, an instruction item relating to the movement of the operable avatar to another entrance room. With the visit function, the operable avatar associated with the user is transferred to and displayed in the entrance room provided for the avatar of another user. The entrance room to which the operable avatar is placed by the visit function may be, for example, determined by the server control unit 201 or determined based on the user's selection of the avatar to visit.

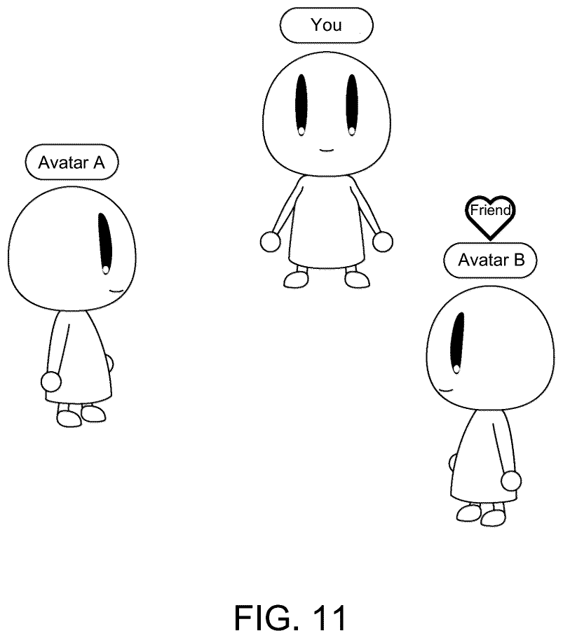

The match-making service provides a friend registration function for operable avatars. On the condition that, for example, a user and an acquaintance or a user with whom the user has played against each other before have agreed to have a friend relationship, a friend relationship can be set to avatars associated with these users. Accordingly, for example, the users having such a friend relationship between avatars can check their login status or easily visit their entrance rooms. For example, when the user's operable avatar is placed in its entrance room and an avatar having a friend relationship with the user visits the entrance room, an icon indicating that the avatar is a friend is displayed in the vicinity of the avatar, as illustrated in FIG. 11. Thus, the user can recognize that the user's friend is visiting. A relationship between avatars that is explicitly displayed is not limited to the friend relationship, but can also include, for example, a relationship that the avatars have played against each other in a battle game in the past.

In this way, with the visit function, a user can let other users see the entrance room associated with the user's own operable avatar. Therefore, in the match-making service according to the present embodiment, each entrance room is configured to allow a corresponding user to change the interior and decoration of the room to produce the uniqueness of the user. Each user can decorate the interior of the entrance room by, for example, placing any decorative object obtained by the user therein.

Further, the interior decoration in the entrance room may include a decorative element which changes in accordance with the state of the operable avatar associated with the entrance room. Such a decorative element may include, for example, an element which changes in accordance with at least one of the number of times a user has played and the number of times the user has won the battle game executed based on match-making established via the operable avatar. Further, in case where a competition, a play season, or the like is available for the battle game, the decorative element may also include an element such as a trophy or a medal which relates to the play result of the battle game executed after match-making is performed via the operable avatar.

(Battle Room) The battle room is a virtual space in which all of the users can be matched with each other for the battle game in the match-making service. Unlike the entrance room, not only the operable avatar but also avatars of other users who have entered the same room are placed in the battle room. The users who have entered the battle room can move their operable avatars within the battle room by performing an operation input relating to the movement. Therefore, in the battle room, each user whose avatar is positioned in the battle room can move the avatar associated with that user and use a function specific to the battle room.

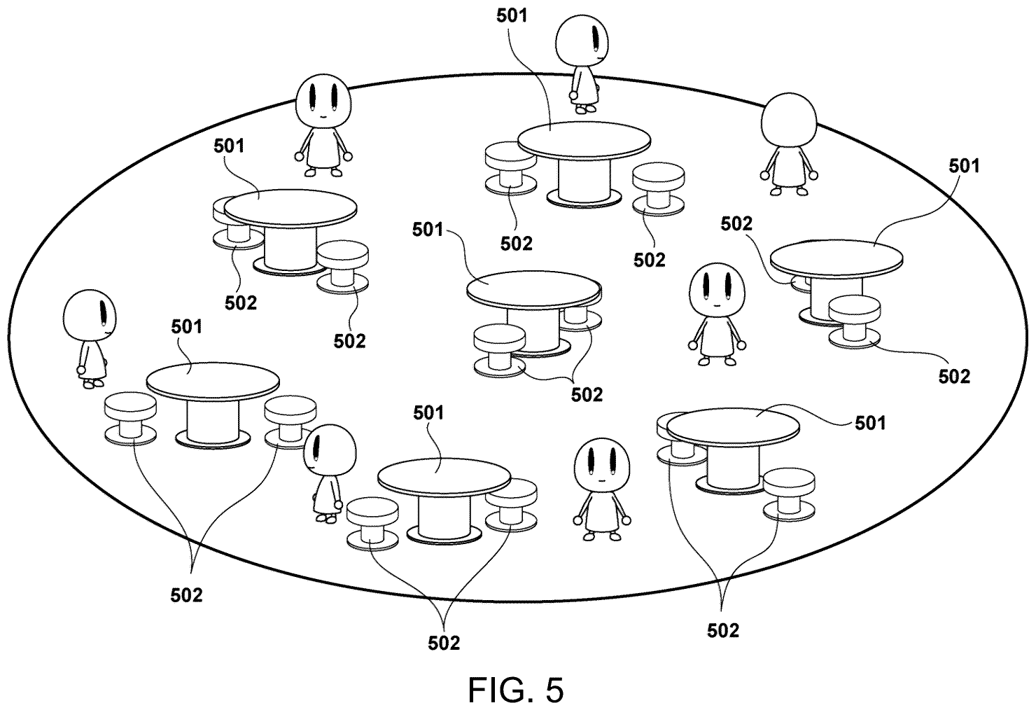

As illustrated in FIG. 5, a plurality of table objects 501 are arranged in the battle room. Further, chair objects 502 are disposed in the vicinity of each table object 501. A user who wants to be matched with another user can use the match-making function by selecting any of the table objects 501. When a match-making request relating to the use of the match-making function is made, the server control unit 201 performs a process relating to the match-making. Further, when the match-making is established through the process relating to the match-making, the match-making service triggers the execution of the battle game relating to the outside service in which the (two) users who have been matched with each other participate.

### (Match-Making Function)

The match-making function matches a user with an opponent for the battle game relating to the outside service. In the match-making service according to the present embodiment, a match-making request is accepted in response to an operation of selecting a table object in the battle room. Therefore, an opponent matched with the user is a user whose avatar is positioned in the same battle room.

The server 200 does not forcibly perform match-making to match the user with an opponent, but performs the match-making after agreement is reached between the users. Specifically, assume that there is a user who wants another user to request to play a battle against the user. In this case, the match-making function allows another user who wants a battle against the user to request a battle to the user. When the user accepts the battle request from the other user, the match-making function establishes the match-making to match the user with the other user. The process relating the match-making starts in response to an operation of selecting one table object, and the state of the process is presented to the user through the display with the table object.

When a user wants to wait for a battle request of another user and performs an operation of selecting a table object, confirmation is displayed to confirm that the state of the operable avatar transitions to a match-making standby state. After that, a match-making request for standby (hereinafter occasionally referred to as “standby request”) is transmitted to the server 200. The standby request may include, for example, identification information which uniquely identifies the table object (a combination of a room ID, which uniquely identifies the battle room, and a table ID, which uniquely identifies the selected table object in the battle room) and identification information which uniquely identifies the user (or the user's operable avatar) who has made the standby request. When the server control unit 201 receives the standby request, the server control unit 201 updates the state of the operable avatar of the user to the match-making standby state and transmits the information to the user terminals 100 of the users who have entered the same battle room.

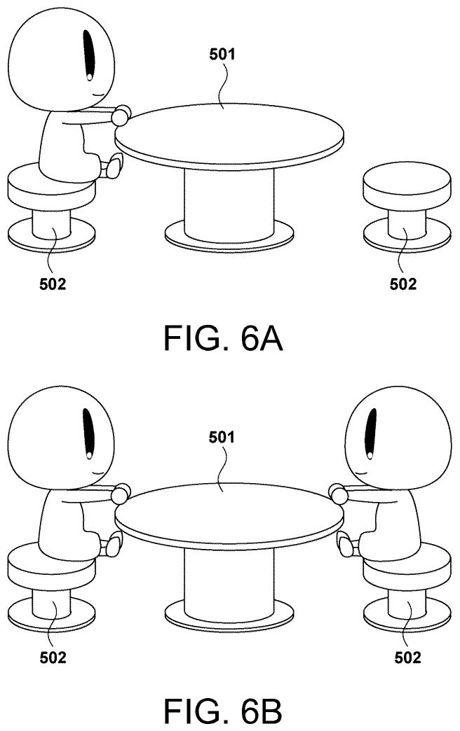

In the match-making standby state (match-making waiting state), the user's operable avatar is displayed such that the operable avatar is seated on one of the chair objects 502 disposed in the vicinity of the table object 501 on which the selection operation has been performed, as illustrated in FIG. 6A. Since a TCG is generally played on a one-to-one basis, two chair objects are disposed in the vicinity of each table object so as to face each other across the table object in the match-making system according to the present embodiment. The display of the avatar in such a seated state continues until the user performs an operation input relating to the cancellation of the standby or until the battle game executed after the establishment of match-making is completed. In other words, the user's operable avatar in the match-making standby state is displayed without moving from the position of the chair object 502 in the vicinity of the table object 501 in the battle room. In the match-making standby state, even when the user performs an operation input relating to the movement of the operable avatar, the operable avatar is controlled so as not to move.

With one user's avatar seated in the chair object 502 and being in the match-making standby state (such a table object 501 will be hereinafter referred to as “standby table”), other users can make a battle request to the table object 501. In other words, the table object 501 is in a state in which a match-making process relating to the match-making standby state is being performed. In response to the match-making process relating to the match-making standby state being performed, the table object 501 is displayed in a different mode from a previous one (when the process is not performed), for example, the color of the table object 501 is changed. Accordingly, other users can recognize that they can make a battle request to the table object 501.

A user who wants to make a battle request can perform an operation input to the standby table to make a battle request to a user (hereinafter referred to as “standby user”) of an avatar which has arrived at the standby table earlier (hereinafter referred to as “standby avatar”). Specifically, for example, when an operation input to the standby table is performed on the user terminal 100 used by the user making the battle request (hereinafter referred to as “requesting user”), the confirmation of making a battle request is displayed and then a match-making request for making the battle request is transmitted to the server 200. The match-making request may include, for example, identification information which uniquely identifies the standby table and identification information which uniquely identifies the requesting user (or the requesting user's operable avatar). When the server control unit 201 receives the match-making request, the server control unit 201 temporarily updates the state of the requesting user's operable avatar (hereafter referred to as “requesting avatar”) to the match-making standby state and shares this information with the user terminals 100 of the users who have entered the same battle room.

When the requesting avatar becomes the match-making standby state, the requesting avatar is displayed such that the requesting avatar is seated in the chair object 502 in the vicinity of the standby table as with the standby avatar, and the requesting avatar and the standby avatar face each other across the table object 501, as illustrated in FIG. 6B. This display continues until the requesting user performs an operation input relating to the cancellation of the battle request, until the standby user performs an operation input relating to the rejection of the battle request, or until the battle game executed after the establishment of match-making is completed. In other words, the requesting avatar in the match-making standby state is displayed without moving from the position of the chair object 502 in the vicinity of the standby table in the battle room. In the match-making standby state, even when the requesting user performs an operation input relating to the movement of the requesting avatar, the requesting avatar is controlled so as not to move.

When the standby avatar and the requesting avatar are seated so as to face each other across the table object 501 in this manner, the server 200 transmits, to the user terminal 100 of the standby user, an inquiry as to whether or not to accept the battle request from the requesting user. The standby user can perform an operation input to accept or reject the battle request made by the requesting user. When the standby user accepts the battle request, the server control unit 201 performs a process of matchmaking the standby user with the requesting user to establish match-making. The server control unit 201 then updates the status information managed for both avatars during the match-making. In other words, the standby user and the requesting user who have been matched with each other become players of the battle game to be subsequently triggered.

In this way, with such a table object disposed in a battle room, match-making can be established between users who have entered the same room. That is, in each battle room, the maximum number of match-making that can be performed at the same time period corresponds to the number of table objects arranged in the battle room. Therefore, the server 200 manages information regarding the state of each table object in each battle room. Examples of the state information include whether the match-making process is being performed, whether the execution of the battle game is triggered after the establishment of match-making, and neither of them is performed (neither the match-making process is being performed nor the execution of the battle game is triggered).

When the battle game is triggered after the establishment of match-making, the corresponding table object 501 may be displayed in a further different mode until the triggered battle game is completed. Changing the display mode of the table object 501 in this way allows other users to recognize that match-making therefor has already been established.

In this way, in the match-making service according to the present embodiment, since a series of processes relating to match-making is performed via the table object 501, avatars are controlled so as not to enter the area where the table object 501 is disposed in the battle room. On the other hand, a standby avatar and a requesting avatar are controlled during the series of processes such that they can be positioned in the area where the chair objects 502 are disposed. Therefore, the avatars are controlled such that they can enter the area where the chair objects 502 are disposed. In this case, only the avatars that are actually involved in the match-making process and positioned in the area of the chair objects 502 are controlled to be seated thereat.

As described above, when the operable avatar is placed in a battle room, the match-making process relating to the match-making function is performed as part of the processing relating to preparation for a play of the battle game performed by using the outside service. More specifically, in the match-making service, upon condition that the operable avatar of the user is placed in a battle room, the match-making process for match-making the user with an opponent for only the game title associated with that battle room, is performed and controlled as part of preparation for a play of the battle game of the game title.

In addition, when the operable avatar is placed in the battle room, the user can perform an operation input relating to a request for transferring the avatar to the entrance room. The operation input corresponding to the request for transferring the avatar to the entrance room can be accepted, for example, in a state where no match-making processing is performed for the operable avatar, that is, the operable avatar is not involved in the match-making and is movably arranged in the battle room. When the transfer request to the entrance room is performed, the operable avatar is repositioned in the entrance room provided for the operable avatar and displayed therein. Thus, the user can reselect the game title to play.

### (Battle Function)

A battle function is a function which executes a battle game in which users who have been matched with each other in a battle room participate. As described above, in the match-making system according to the present embodiment, the battle game is realized using the outside service.

After match-making is performed in the battle room, the server 200 transmits a request to a game server of the outside service, which is not illustrated, to create a connection destination of a battle game, together with information regarding the two players (a standby user and a requesting user) who have been matched with each other. The game server creates a new connection destination of the new battle game in response to the creation request and transmits connection destination information to the server 200. The server 200 then transmits, together with a transfer instruction, the received connection destination information to the user terminal 100 used by each player. At the user terminal 100 which has received the transfer instruction, a connection to the connection destination is triggered on the browser and the display is switched from the match-making service to the outside service. This configuration eliminates the need for each player to directly perform a registration procedure for the outside service and allows each player to start the battle game against the player's opponent who has been matched with the player in the match-making service.

In the present embodiment, the login state in the match-making service is maintained even while the display of the user terminal 100 has transitioned to the outside service (during the execution of the battle game in the outside service) so that each player can easily return to the match-making service after finishing the battle game. In more detail, for example, when the user terminal 100 of each player receives information regarding the connection destination of the outside service, the user terminal 100 opens a different tab (or a different window) of the browser and establishes a connection to the connection destination. Accordingly, the tab for the outside service is displayed as a main tab. That is, the tab for the outside service is selected as a display tab and the display of the browser is switched thereto (the tab for the outside service is displayed instead of a tab displaying the service screen of the match-making service, or a different window section is displayed at the front). This triggers temporal transition from the match-making service to the outside service. At this time, the tab for the match-making service is still present even while the outside service is in use. Therefore, each player can check both the state of the battle room in the match-making service and the play screen of the battle game in the outside service.

As described above, the battle game relating to the outside service for which the match-making system according to the present embodiment matchmakes players is a TCG. Simply put, a TCG proceeds as follows. Each player builds a deck using game cards which are real items and obtains a game card that serves as an initial hand from a shuffled deck. Each player adds, on their turn, a game card from the deck to his or her hand and, when necessary, arranges the cards in his or her hand on a play field. A player declares the action of a card placed on the play field and performs various operations relating to the resolution of the declaration. Therefore, it is essential to be able to check the state of the playing field of each player in the progress of the battle game. For this reason, the battle game executed using the outside service proceeds using a video chat function to share, among the players, a video(s) capturing the players' hands and a voice(s) of the declaration made by the players.

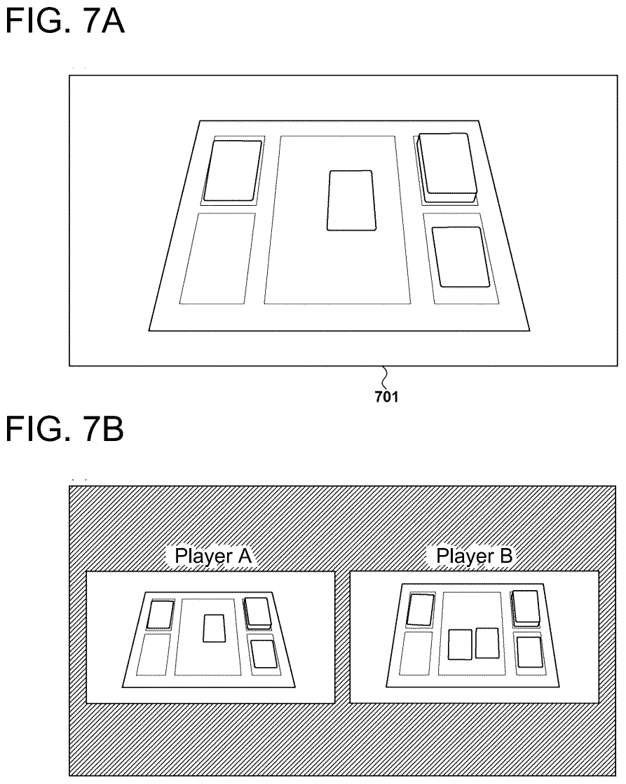

The screen (play screen) displayed on the user terminal 100 used by a player during the game play may, for example, display a live video 701 itself captured by the user terminal 100 used by an opponent of the player, as illustrated in FIG. 7A. In the example of FIG. 7A, the video 701 captured by the user terminal 100 used by the opponent is displayed as it is in full screen. Alternatively, the play screen may display a frame image of the video 701 with a predetermined GUI.

When the battle game relating to the outside service ends, the display of the user terminal 100 used by each player returns from the outside service to the match-making service. The information (end information) indicating that the players have finished using the outside service may be transmitted from the user terminal 100 of at least one of the players to the server 200 or may be transmitted directly from the game server of the outside service to the server 200. The end information also includes information regarding the result (win or loss) of the battle game. To display the result of the battle game played by each player based on the received end information, the server 200 performs control so as to transmit, together with a display request, information for displaying the result of the battle game to the user terminals 100 used by the players. When the user terminal 100 of each player receives the information, the user terminal 100 displays the result of the battle game executed using the outside service.

Further, when the server control unit 201 receives result information regarding the battle game played by the players, the server control unit 201 updates information regarding the battle result managed for the corresponding users and also updates the state of the avatars of the users from a matched state to a non-matched state (free state). The avatar of each user whose state has been changed to the free state is no longer seated in the chair objects in the vicinity of the table object and is displayed as an away state. Then, the avatar can move between the battle rooms again according to an operation input performed by the user terminal 100 used by the user as with the state becoming the match-making standby state.

### (Spectator Function)

A spectator function allows users other than players to watch a battle game whose execution has been triggered via a battle room. In other words, the match-making service according to the present embodiment provides a function relating to watching of the battle game executed via the battle room as an element of entertainment that can be enjoyed by users who have entered the battle room but are not matched. The spectator function may be realized by using, for example, a publication function provided by the outside service relating to the battle game. The publication function publishes the play screen transmitted and received between the user terminals 100 used by the players who are playing the battle game.

For example, a user can make a spectator request to watch a battle game executed via a table object by performing, on the service screen of the match-making service, an operation input to the table object through which the battle game is being executed. In response to the user making the spectator request to the table object where match-making has been established, the user terminal 100 used by the user making the spectator request switches the display to display the play video of the battle game relating to the table object. In this case, the user's operable avatar may be controlled so as to be displayed to other users such that the user's operable avatar is watching the table object in the vicinity of the table object, for example.

With the spectator function, the display 110 of the user terminal 100 of the user who has made the spectator request may display, for example, a video focusing on cards at one player's hand as illustrated in FIG. 7A or an image including videos of cards at both players' hands during the battle game as illustrated in FIG. 7B.

### (Switching of Service Provision Mode)

By the way, in battle games which progress using game cards (real items) such as TCGs (Trading Card Games), players need to acquire game cards and build a deck (a set of game cards used for one match) based on strategies planned using the acquired game cards. Furthermore, if the same deck is used in multiple matches, an opponent(s) and spectators would recognize it, thereby making it easier to be countered with counter-decks, and thereby making it difficult to continuously achieve favorable results. Therefore, each user tends to update his or her deck by replenishing it with new game cards or devising new strategies each time they use the match-making service to engage in the battle games.

Considering such characteristics of the TCG, it is thought that the match-making service should be operated not by constantly providing the match-making service but providing the match-making service with a time interval, which would better meet the users' demands. In other words, by setting such a time interval between matches to be played, a deck preparation time for the users is secured, thereby enabling the provision of play experience with an enhanced entertainment aspect. Moreover, by limiting the time interval between matches to be played, users who wish to engage in match-making are encouraged to use the service during the time intervals, thereby simply making the match-making process easy to establish, and ensuring play opportunities for each user.

On the other hand, if the match-making service is available only during a period when battle games can be played, users may be unfamiliar with the system of the match-making service using virtual spaces, so that match-making between users may not be carried out optimally during the period(s). In other words, if the match-making service is only available during period(s) when battle games can be played, the users may need to start by familiarizing themselves with the structure and functions of each virtual space and the movement operations of the avatars within these virtual spaces, so that there is possibility that these periods cannot be effectively used.

Therefore, the matching system according to the present embodiment is configured to offer the match-making service in two different modes. These two mode services are provided to users at different times. In either mode, users who log in to the service can move their avatars within a virtual space through a movement-related input operation(s). That is, when a user logs in to the service, an avatar placed in the virtual space is displayed on the user's terminal. However, the services in each mode differ at least in whether or not the match-making for an opponent of a battle game is performed when the input operation related to a match-making request is made within the virtual space.

In the following explanation, the match-making service includes two types of periods, that is, a first period during which an event(s) related to the battle game is held (hereinafter referred to as an event period in the present embodiment), such as a player interaction event(s), and a second period during which such an event is not held (hereinafter referred to as a non-event period in the present embodiment). The services provided to users are switched between the event period and the non-event period, with the first mode service being provided during the event period and the second mode service being provided during the non-event period.

In the first mode service, users can move their avatars within the virtual space, and when their avatars are placed in the battle room, each of them can select a table object for match-making with an opponent and plays a battle game through an outside service. That is, the first mode service is configured to accept a match-making request for the battle game from a user whose avatar is placed therein and can be moved to the battle room.

On the other hand, in the second mode service, although a user can move his or her avatar within the virtual space, even if a table object is selected when the avatar is placed in the battle room, match-making for an opponent is not performed, and thus the battle game through the outside service cannot be played. That is, the second mode service is configured not to be able to accept any match-making request for the battle game from the users whose avatars are placed and can moved to the battle room.

In this way, in the second mode service, since the opponent match-making function is not provided, when transferring from the entrance room to the battle room, multiple game titles for which match-making can be performed are not presented, and selection of the game title to play is not required. Such a selection of the game title to play is only available when multiple game titles are displayed in the entrance room on condition that it is currently the event period.

In the match-making service according to the present embodiment, users can move their avatars within the virtual space in both the first mode service and the second mode service, and the area where movement is possible is the same regardless of the mode of service provided. That is, the area within which users can move their avatars is set to be the same in both the first and second modes of service.

Furthermore, the second mode service is provided to familiarize users with the virtual space and to increase the number of users using the match-making service during the event period. In order that the second mode service is also provided so that users can use the service with the same case as that in the first mode service, in the present embodiment, both the first mode service and the second mode service are provided free of charge.

From the perspective of allowing users to fully prepare their decks and publicize events related to battle games thereby increase service use during the event period, the event period is set to be shorter than the non-event period. Additionally, to increase users' participation opportunities, multiple events related to the battle games are held, and the match-making service is configured so that the event period and the non-event period are alternatively provided.

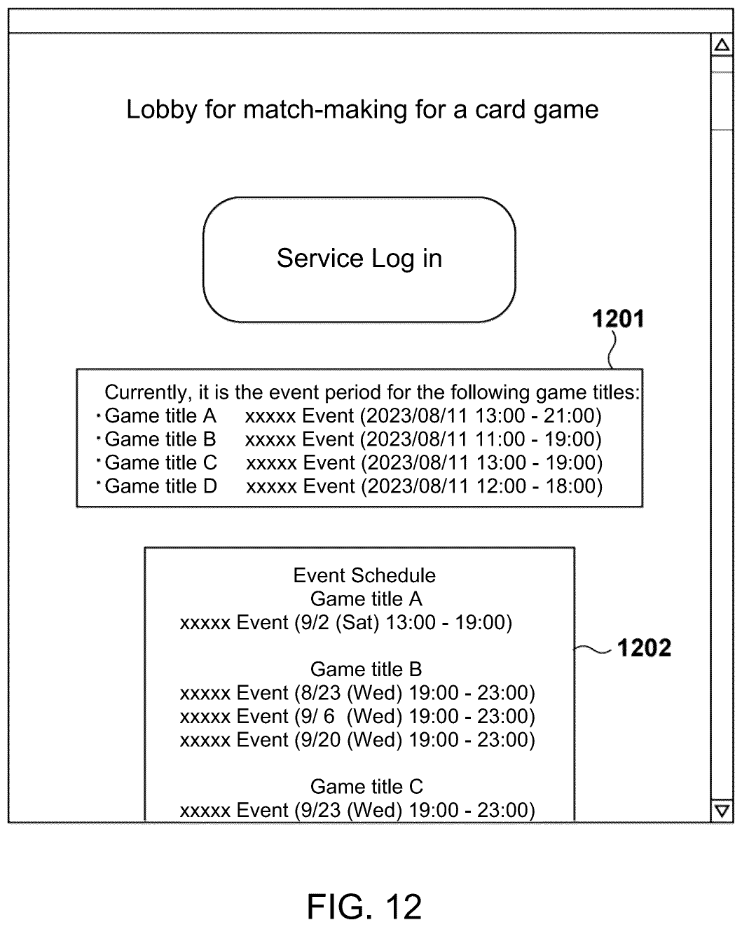

As shown in FIG. 12, for example, whether it is currently the event period or the non-event period can be presented so that users can confirm it before logging in to the service site. In the example shown in the figure, there is an information display area 1202 on which the schedule of the event periods is announced to users, in addition to an information display area 1201 on which whether it is currently the event period or the non-event period is shown.

### <<Information Management>>

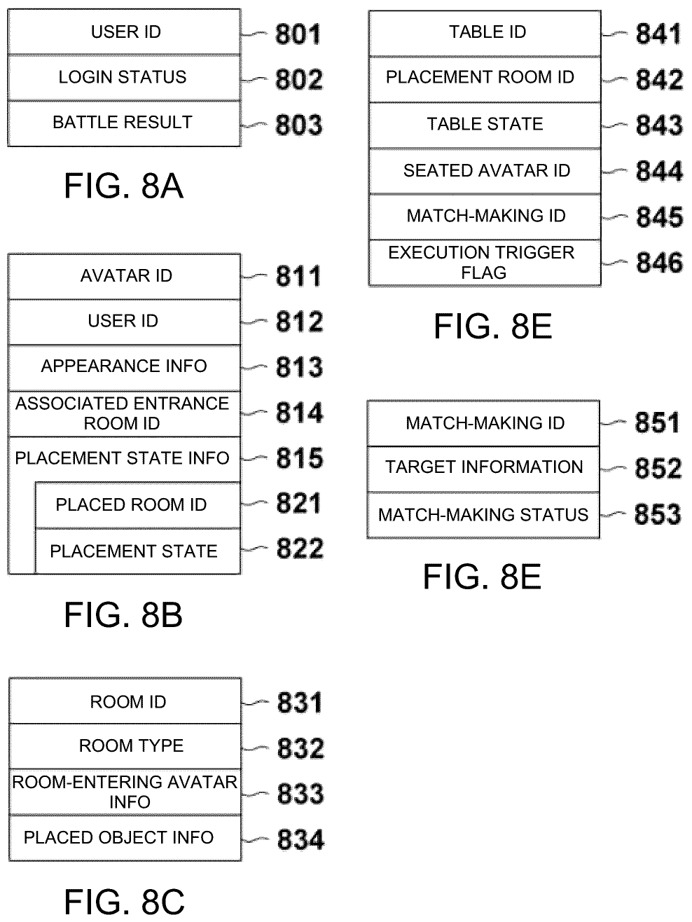

An example of a configuration of various kinds of information managed by the server 200 in relation to the match-making service according to the present embodiment, which is configured as described above, will be described with reference to FIGS. 8A to 8E.

FIG. 8A illustrates an example of a configuration of user information managed for each user. As illustrated in FIG. 8A, the user information managed for each user includes a user ID 801, login status 802, and a battle result 803. The login status 802 and the battle result 803 are managed in association with the user ID 801. The user ID 801 uniquely identifies the user. The login status 802 indicates whether the user is logged in to the service. The battle result 803 indicates the result of the battle game played by the user via the match-making service. When a service login request associated with the user ID 801 is received via the service site or when a service logout request is received, the login status 802 is updated to a corresponding value. Further, when match-making has been established and the executed battle game has ended, the battle result 803 is updated based on the received information regarding the battle result (result information). The result information may be received from the game server of the corresponding outside service or may be input by each user who has participated in the battle game.

FIG. 8B illustrates an example of a configuration of avatar information managed for each avatar. As illustrated in FIG. 8B, the avatar information managed for each avatar includes an avatar ID 811, a user ID 812, appearance information 813, an associated entrance room ID 814, and placement state information 815. The user ID 812, the appearance information 813, the associated entrance room ID 814, and the placement state information 815 are managed in association with the avatar ID 811. The avatar ID 811 uniquely identifies the avatar. The user ID 812 uniquely identifies the user associated with the avatar. The appearance information 813 indicates the appearance of the avatar. The associated entrance room ID 814 uniquely identifies the entrance room associated with the avatar. The placement state information 815 indicates the current positioning state of the avatar in the virtual space. When the avatar is positioned in the entrance room and an appearance change request relating to the appearance customization function is received, the appearance information 813 is updated. The placement state information 815 includes a placed room ID 821 and a placement state x. The placed room ID 821 uniquely identifies the room (virtual space) in which the avatar is positioned. The placement state 822 indicates the state of the avatar in the room. The state of the avatar indicated by the placement state 822 includes the match-making standby state, the match-making establishing state (or the battle game executing state), and the free state. The placement state 822 is mainly used to indicate the information regarding the avatar in the battle room. When the avatar is positioned in the battle room and any of various requests relating to the match-making function is received, the placement state 822 is updated to a corresponding value.

FIG. 8C illustrates an example of a configuration of virtual space information managed for each room. As illustrated in FIG. 8C, the virtual space information managed for each room includes a room ID 831, a room type 832, room-entering avatar information 833, and placed object information 834. The room type 832, the room-entering avatar information 833, and the placed object information 834 are managed in association with the room ID 831. The room ID 831 uniquely identifies the room. The room type 832 indicates whether the room is the entrance room or the battle room. The room-entering avatar information 833 is information regarding each avatar who has entered the room. The placed object information 834 is information regarding each object placed in the room. The room-entering avatar information 833, which includes information regarding each avatar which has entered the room, includes, for example, the avatar ID of the avatar and information required for drawing the room, such as the position, posture, and appearance of the avatar in the room in which the avatar is placed. When the avatar is seated in the chair object, the position information and posture information of the avatar may be values uniquely specified for the chair object. When the avatar is placed in the entrance room, the placed object information 834 may include information regarding, for example, decorations placed in the entrance room. When the user is placed in the battle room, the placed object information 834 may include table information regarding each of the table objects disposed in the room.

In addition, when the room type 832 is a battle room, the information includes game title information associated with the battle room. That is, the room type 832 indicates whether it is an entrance room or a battle room in which match-making process is performed for any of the game titles.

The virtual space information is sequentially updated according to the changes of the states of the avatars and table objects positioned in a corresponding room, and is shared each time among the user terminals 100 used by the users whose avatars are placed in the same virtual space. With the virtual space information, the user terminals 100 can draw the virtual space in which the corresponding operable avatars are positioned.

FIG. 8D illustrates an example of a configuration of table information managed for each table object disposed in the battle room. As illustrated in FIG. 8D, the table information managed for each table object includes a table ID 841, a placed room ID 842, a table state 843, a seated avatar ID 844, a match-making ID 845, and an execution trigger flag 846. The table state 843, the seated avatar ID 844, the match-making ID 845, and the execution trigger flag 846 are managed in association with the table ID 841 and the positioning room ID 842. The table ID 841 may be an identification number assigned to each table object in the room. The positioning room ID 842 uniquely identifies the room. The table state 843 indicates the use state of the table object. The seated avatar ID 844 uniquely identifies the avatar seated in the chair object associated with the table object. The match-making ID 845 uniquely identifies the match-making process being performed via the table object. The execution trigger flag 846 indicates whether or not the execution of the battle game has been triggered via the table object. A combination of the table ID 841 and the placed room ID 842 uniquely identifies each of the table objects managed in the match-making service.

The state of the table object indicated by the table state 843 includes the state in which the match-making process is being performed, the state in which the triggered battle game is being executed, and the state in which none of these are performed (the triggered battle game has ended or the match-making process has not started). When the avatar is positioned in the battle room and a match-making request relating to the match-making function is received or the execution of the battle game is triggered or when result information regarding the result of the battle game is received, the table state 843 is updated to a corresponding value. When the avatar is positioned in the battle room and the match-making request based on the operation of selecting the table object is received, the seated avatar ID 844 is updated based on the identification information of the avatar. When, for example, the match-making process for the table object starts, the match-making ID 845 is issued and stored in the table information as information which is referred to for the match-making process. The match-making ID 845 is deleted in response to the completion (establishment or cancellation) of the match-making process or the end of the battle game that has been triggered and executed. The execution trigger flag 846 is, for example, a logical type of information. When the battle game is being executed on the outside service after the establishment of match-making, the execution trigger flag 846 is set to true (True). When the battle game is not being executed, the execution trigger flag 846 is set to false (False).

FIG. 8E illustrates an example of a configuration of match-making information managed for the match-making process being performed for each table object. As illustrated in FIG. 8E, the match-making information relating to the match-making process includes a match-making ID 851, target information 852, and a match-making status 853. The target information 852 and the match-making status 853 are managed in association with the match-making ID 851. The match-making ID 851 uniquely identifies the match-making process. The target information 852 indicates a target to be matched in the match-making process. The match-making status 853 indicates the progress of the match-making process. The target information 852 can be, for example, the user ID of the user who is the target of the match-making, the avatar ID of the user's operable avatar, or both. The target information 852 is updated when a match-making request is received for the table object. The progress indicated by the match-making status 853 includes a match-making standby state, a state in which a request has been made, and a state in which match-making has been established. The match-making status 853 is set to the match-making standby state when the match-making process starts for the table object. After the match-making standby state, the match-making status 853 is further updated according to a match-making request relating to a battle request received for that table object or according to the contents of the response to the battle request.

These pieces of information are generated, managed, and updated by the server control unit 201. Further, these pieces of information can also be stored and managed using an external storage server or the like instead of or in addition to the server storage device 202 and the server memory 203.

### <<Switching Process>

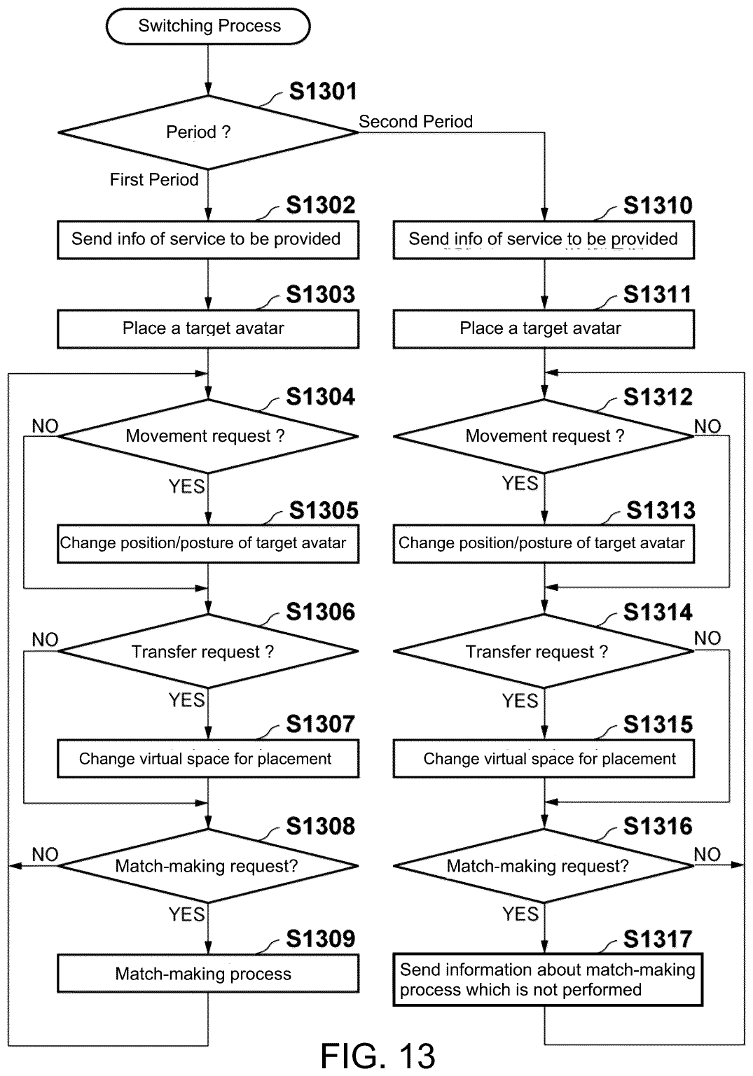

A switching process executed with respect to switching of match-making service modes to be provided will be described, referring to a flowchart shown in FIG. 13. The server control unit 201 can perform the process corresponding to the flowchart by reading out a corresponding processing program stored in the server storage device 202, deploying the processing program in the server memory 203, and executing the processing program. This switching process starts when, for example, the server 200 receives a service login request of the match-making service from a user terminal 100. In the explanation of the switching process, the user terminal 100, which sends the service login request is referred to as a target terminal. A user who uses the target terminal is referred to as a target user. Further, an operable avatar associated with the target user is referred to as a target avatar. In addition, in parallel with the switching process, necessary information related to the provision of the match-making service, including virtual space information is send to the target terminal, and used for displaying a service screen in the target terminal.

In S1301, the server control unit 201 determines whether the current time is within the event period or the non-event period. If the server control unit 201 determines that the current time is within the event period, the process moves to S1302. If it determines that the current time is within the non-event period, the process moves to S1310.

In S1302, the server control unit 201 controls to send information to the target terminal, indicating that the first mode service is provided. Based on the information sent in this step, the display 110 of the target terminal shows information to the effect that the current time is within the event period and the first mode service is provided.

In S1303, the server control unit 201 performs the process of placing the target avatar in the virtual space. At this time, the server control unit 201 updates the placement information 815 of the avatar information related to the target avatar and the room entering avatar information 833 of the virtual space information related to the virtual space in which the avatar is placed. Specifically, the server control unit 201 updates the placed room ID 821 of the placement state information 815 of the relevant avatar information to the room ID of the virtual space where the target avatar is placed, and updates the placement state 822 to the free state. Furthermore, the server control unit 201 adds and updates the information related to the target avatar in the room entering avatar information 833 of the virtual space information. In the match-making service according to the present embodiment, the virtual space where the target avatar is initially placed upon the service login is the entrance room associated with the target avatar. Therefore, that room ID of the entrance room is inputted as the placed room ID 821. Additionally, the virtual space information related to the entrance room is subject to the update in the room entering avatar information 833.

In S1304, the server control unit 201 determines whether or not a movement request of the target avatar has been received. That is, the server control unit 201 determines whether or not the movement request, which is sent in response to an operation input related to the movement of the target avatar within the virtual space, has been received from the corresponding terminal. If the server control unit 201 determines that the movement request has been received, the process proceeds to S1305. If it determines that the request has not been received, the process proceeds to S1306.

In S1305, the server control unit 201 performs the process of changing the position and posture of the target avatar in the virtual space based on the received movement request. At this time, the server control unit 201 updates the information related to the target avatar included in the room entering avatar information 833 of the virtual space information related to the virtual space where the target avatar is placed, based on the operation input amount information included in the movement request.

In S1306, the server control unit 201 determines whether or not a transfer request for the virtual space has been received from the target terminal. That is, the server control unit 201 determines whether or not the transfer request, which is sent in response to an operation input related to the transfer of the virtual space, has been received from the target terminal. If the server control unit 201 determines that the transfer request has been received, the process moves to S1307. If it determines that the request has not been received, the process moves to S1308.

In S1307, the server control unit 201 performs the process of changing the virtual space where the target avatar is placed based on the received transfer request. At this time, the server control unit 201 updates the placement state information 815 of the avatar information related to the target avatar, the room entering avatar information 833 of the virtual space information related to the current virtual space, and the room entering avatar information 833 of the virtual space information related to the virtual space where the avatar is placed after the transfer. Specifically, the server control unit 201 updates the placed room ID 821 of the placement state information 815 of the relevant avatar information, to the room ID of the virtual space to be moved, and updates the placement state 822 to a free state. Furthermore, the server control unit 201 deletes the information related to the target avatar, from the room entering avatar information 833 of the virtual space information related to the current virtual space. Additionally, the server control unit 201 adds the information related to the target avatar, to the room entering avatar information 833 of the virtual space information related to the virtual space where the avatar is placed after the movement.

In S1308, the server control unit 201 determines whether or not a match-making request has been received from the target terminal. That is, the server control unit 201 determines whether or not the match-making request, which is sent in response to an operation by the user who selects any one in the battle room in a state where the target avatar is placed, has been received from the target device. If the server control unit 201 determines that the match-making request has been received, the process moves to S1309. If it determines that the request has not been received, the process returns to S1304.

In S1309, the server control unit 201 performs the match-making process to match the target avatar based on the received match-making request. In executing this match-making process, the server control unit 201 generates or updates match-making information. Additionally, the server control unit 201 updates the placement state 822 included in the placement state information 815 of the avatar information related to the target avatar and the table information related to the table object associated with the match-making request.

The detailed explanation of the switching process in this embodiment is omitted, but the match-making process executed in this step may be terminated based on the conditions such as the cancellation of the match-making request, the withdrawal of the match-making request by the standby user, or the establishment of match-making. The server control unit 201 terminates the process in this step and returns the process to S1304 based on the condition that the match-making process related to the target avatar has ended due to the failure of the match-making, or the completion of the battle game executed based on the establishment of the match-making.

On the other hand, if it is determined in S1301 that the current time is within the non-event period, the server control unit 201 controls to send information to the target terminal indicating the second mode service is being provided in S1310. Based on the information sent in this step, the display 110 of the target terminal shows information to the effect that the current time is within the non-event period and the second mode service is provided.

In S1311, the server control unit 201 performs the process of placing the target avatar in the virtual space. The process in this step may be similar to that in S1303.

In S1312, the server control unit 201 determines whether or not a movement request of the target avatar has been received. If the server control unit 201 determines that the movement request has been received, the process proceeds to S1313. If it determines that the request has not been received, the process proceeds to S1314.

In S1313, the server control unit 201 performs the process of changing the position and posture of the target avatar in the virtual space based on the received movement request. The process in this step may be the same as or similar to that in S1305.

In S1314, the server control unit 201 determines whether or not a transfer request for the virtual space has been received from the target terminal. If the server control unit 201 determines that the transfer request has been received, the process moves to S1315. If it determines that the request has not been received, the process moves to S1316.

[In S1315, the server control unit 201 performs the process of changing the virtual space where the target avatar is placed, based on the received transfer request. The process in this step may be the same or similar to that in S1307.

In S1316, the server control unit 201 determines whether or not a match-making request has been received from the target terminal. If the server control unit 201 determines that the match-making request has been received, the process moves to S1317. If it determines that the request has not been received, the process returns to S1312.

In S1317, the server control unit 201 sends information to the target terminal indicating that the match-making process will not be executed and returns the process to S1312. Based on this information, the target terminal notifies the user that match-making with an opponent cannot be performed because it is currently the non-event period. That is, the server control unit 201 controls to make it impossible to matchmake the target user with an opponent during the non-event period, even if a match-making request is received. In the switching process according to the present embodiment, it was explained that the server control unit 201 does not execute the match-making process in the second mode service even if the match-making request is received, but the implementation of the present invention is not limited to this. For example, it is also possible to make such matchmaking with opponent impossible by not accepting a selection operation for a table object in the battle room or by configuring the target terminal not to send the match-making request to the server 200 even if a selection operation is made.

### <<Event Period Process>>

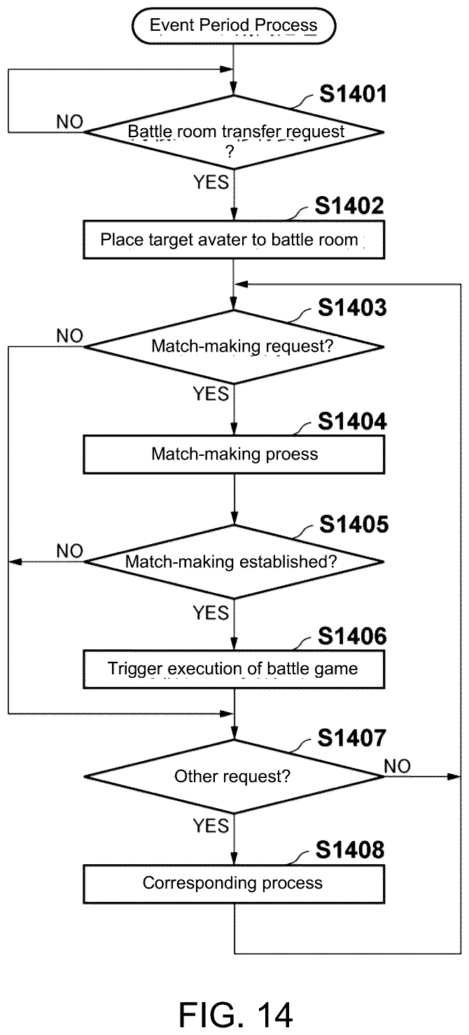

Next, the event period process according to the present embodiment, which is executed by the server 200 regarding matchmaking of users during the event period will be specifically described using the flowchart shown in FIG. 14. The process corresponding to the flowchart can be realized by the server control unit 201, which reads out the corresponding processing program stored in the server storage device 202 and executes it by deploying it in the server memory 203. It should be noted that this event period process partially corresponds to the process in S1306 to S1309 for the aforementioned switching process. The event period process is described as starting on the condition that the target avatar is placed in the entrance room, by the process in S1303. In the switching process described above, the process upon receiving the transfer request without regard with the type of virtual space is explained, but the event period process mainly relates to the service provided when the transfer request from the entrance room to the battle room is received. In the following explanation about the event period process, the user terminal 100 which sends a service login request is referred to as a target terminal, a user using the target terminal is referred to as a target user, and an operable avatar associated with the target user is referred to as target avatar.

In S1401, the server control unit 201 determines whether or not a transfer request to the battle room has been received from the target terminal. If the server control unit 201 determines that the transfer request to the battle room has been received, the process moves to S1402. If it determines that the request has not been received, the processing in this step is repeated.

In S1402, the server control unit 201 selects a battle rooms associated with the play title based on the information of the play title included in the received transfer request and performs the process of changing the virtual space where the target avatar is placed, from the entrance room to the battle room.

In S1403, the server control unit 201 determines whether or not a match-making request has been received from the target terminal. If the server control unit 201 determines that the match-making request has been received, the process moves to S1404. If it determines that the request has not been received, the process moves to S1407.

In S1404, the server control unit 201 executes the match-making process based on the match-making request. The match-making request includes information that uniquely identifies the table object selected by the target user. Here, the table objects managed by the server 200 in the match-making service are identified by the combination of the identification number (table ID 841) that uniquely identifies the table object in the battle room and the identification information (placed room ID 842) that uniquely identifies the battle room, as shown in the table information. Therefore, when the server control unit 201 receives the a match-making request, it executes the match-making process for the game title associated with the battle room identified by the placed room ID included in the match-making request. That is, by executing the match-making process, the server control unit 201 performs match-making for the target user with other users who have made a match-making request for the same game title as that selected by the target user for play.

In S1405, the server control unit 201 determines whether or not the match-making was successful based on the match-making process executed for the target user. If the server control unit 201 determines that the match-making was successful, the process moves to S1406. If it determines that the match-making was not successful, the process moves to S1407.

In S1406, the server control unit 201 triggers the execution of the battle game in an outside service that provides the game title service for the table object, in which the match-making is established. That is, the server control unit 201 sends a request for creating a connection destination for the battle game to the game server of the outside service, and sends the connection destination information obtained in response to the request for creating a connection destination, along with the transfer command, to the target terminal and the user terminal 100 of the opponent, thereby controlling the terminals to connect to the game server and execute the battle game. Through the process in this step, the battle game involving the target user and the opponent matched with the target user is executed. After that, when the server control unit 201 receives the result information related to the end of the battle game, the process moves to S1407.

In S1407, the server control unit 201 determines whether or not a request related to other functions available in the battle room has been received from the target terminal. If the server control unit 201 determines that the request related to the other functions has been received from the target terminal, the process moves to S1408. If it determines that the request has not been received, the process returns to S1403.

In S1408, the server control unit 201 executes the process according to the received request and returns the process to S1403.

As described above, according to the match-making system of this embodiment, it is possible to provide a match-making service with improved convenience.

In this embodiment, it was explained that the area within the virtual space where the operable avatar can move is the same for both the first mode service (event period) and the second mode service (non-event period), but the implementation of the present invention is not limited to this. For example, in the second mode service, the area within the virtual space where movement is possible may be narrower than that in the first mode service. In other words, in the first mode service, the area within the virtual space where movement is possible may be wider than in the second mode service.

Additionally, in this embodiment, the period when any event is not conducted is described as the non-event period, but the implementation of the present invention is not limited to this. That is, the second mode service can be provided during a period different from the period when the first mode service is provided, as long as it allows users to experience the service which uses the virtual space. It is not necessary to make all periods when the first mode service is not provided, into periods when the second mode service is provided. The period during which the second mode service is provided may be set so that it does not overlap with at least the event period during which the event is conducted.

### Modified Example 1

In the embodiments described above, each battle room primarily provides the match-making function, which matchmakes users, and the spectator function. However, embodiments of the present invention are not limited thereto. Each battle room may, for example, provide a function for selling/purchasing a relevant item relating to the game content for which match-making is performed. For example, when the battle game for which the match-making function is provided is a TCG, the sale/purchase function may be provided to sell or purchase real items (game cards) that can be used in the TCG. As the sale/purchase function, a payment procedure may be performed in the match-making service. Alternatively, the sale/purchase function may be provided indirectly. For example, the user terminal 100 may be transferred to a sales page of a target product on an e-commerce (EC) website.

Further, the relevant items do not need to be real items. Instead, the relevant items may include, for example, in-game items or downloadable content.

The sales/purchase function may be provided, for example, during an event period. That is to say, in the modified version of the match-making service, during the event period, a third mode service, which relates to the sales/purchase function of related products, is provided in addition to the first mode service.

For example, the sale/purchase function may be usable in an area (second area) different from an area (first area) in a battle room. The first area refers to an area in which the match-making function is provided in the battle room, that is, an area in which a table object is disposed. In such an embodiment, for example, the match-making function is configured to be made available to the user on the condition that the operable avatar is positioned in the first area, while the sale/purchase function is configured to be made available to the user on the condition that the operable avatar is positioned in the second area. That is, the server control unit 201 accepts a match-making request from the user terminal 100 and performs the match-making process on the condition that the operable avatar of the user of the user terminal 100 is positioned in the first area, while the server control unit 201 accepts a purchase request for a relevant item from the user terminal 100 and performs a sale-related process on the condition that the operable avatar of the user of the user terminal 100 is positioned in the second area.

### Modified Example 2

In the above-described embodiment, it was explained that when an operable avatar is placed near the window section 901 provided within the entrance room, the user interface for selecting a game title to play is displayed on the window section 901. However, the implementation of the present invention is not limited to this. To make it easier for users to understand that they need to perform a selection operation of the game title to play in the window section 901 at time of movement to the battle room, for example, a control may be performed so that the user interface is displayed only when the operable avatar is in a state the operable avatar faces the window section 901.

### Modified Example 3

In the above-described embodiment, it was explained that the selection of the game title to play can be accepted when the operable avatar is near the window section 901 of the entrance room. However, the implementation of the present invention is not limited to this. For example, instead of or in addition to the condition that the avatar is placed near the window section 901 of the entrance room, the user interface may be displayed near its placement position (window section 901, wall portion) when the operable avatar is placed near the wall portion, so that the selection operation by the user can be accepted.

Furthermore, a place for displaying the user interface for selecting the game title to play in the entrance room is not limited to the window section 901 or the wall portion. The user interface may be displayed somewhere in the entrance room when the operable avatar is placed in a specific position set within the entrance room. Additionally, the user interface for selecting the game title to play can also be displayed, using a window section, by a function menu set up for a match-making service.

### Modified Example 4

In the embodiments described above, an operation input relating to the use of the match-making function is acceptable via a table object disposed in a battle room. However, the embodiments of the present invention are not limited thereto. For example, positioning an operable avatar at a specific position in the battle room may enable an operation input relating to the use of the match-making function without using any object.

### Modified Example 5

In the embodiments described above, the battle game of the outside service for which match-making is provided in the match-making service has been described as a TCG. However, the embodiments of the present invention are not limited thereto. The battle game for which match-making is provided may be a battle game of another genre. Further, the game for which match-making is provided is not limited to a battle game. As long as a plurality of users can participate in the game, the game for which match-making is provided may be, for example, a game involving cooperative play etc.

Further, the game in which match-making is provided does not need to be a game which is performed using the outside service but may be a game provided as a function of the match-making service. That is, the match-making service may include a function of executing an online game in which users matched with each other by the match-making process participate. In such an embodiment, the server control unit 201 further performs a process corresponding to a game function provided by the match-making service to control the trigger of the execution of a battle game after the establishment of match-making. Accordingly, when the game provided by the game function is a TCG, the server control unit 201 controls information to be transmitted to each user terminal 100 such that the display 110 of the user terminal 100 used by one of the users participating in the TCG displays, instead of the service screen, an image captured by the imaging unit 120 of the user terminal 100 used by the other user (opponent).

### Modification Example 6

In the above-described embodiment, the mode where the server control unit 201 executes the process in the event period was explained. However, the functions corresponding to this process can also be performed by the control unit 101. For example, in response to the detection of an operational input according to each of various requests, the control unit 101 sends a request related to the use of the corresponding function to the server 200, thereby having the server 200 execute some steps of the process and then obtaining the result, and the function corresponding to the process in the event period can be realized, by triggering an action such as screen display or execution of the battle game.

### Modified Example 7

In the embodiments described above, the match-making service is provided from the server 200 to the user terminal 100 which has logged in to the service via the browser. Alternatively, the match-making service may be provided via a dedicated application installed on the user terminal 100. In this case, in order to provide the match-making service, the dedicated application may connect to an external apparatus including the server 200, transmit a processing request for part of the functions to the external apparatus, and acquire a processing result to control the display or the like relating to the dedicated application. 137

### Modified Example 8

In the embodiments and modifications described above, the virtual space provided in the match-making service is a three-dimensional space in which three-dimensional models are arranged. However, the embodiments of the present invention are not limited thereto. For example, the present invention can also be applied to, for example, a two-dimensional space in which two-dimensional models are arranged.

### SUMMARY OF THE EMBODIMENTS

In the above-described embodiments, a program, a match-making server, and a match-making system are at least disclosed.

(1) A program causes a computer to execute: a display control processing which displays a virtual space where a virtual character associated with a user is placed so as to be movable; and a control processing which executes processing in response to a request from the user depending on the virtual space in which the virtual character of the user is placed, wherein the virtual space includes a first virtual space and a second virtual space, in the control processing, a selection of a game title to play from two or more game titles by the user is accepted when the virtual character of the user is placed in the first virtual space, processing related to preparation for a game play of of the game title to play is performed when the virtual character of the user is placed in the second virtual space and, in the display control processing, the virtual character of the user placed in the first virtual space is placed in the second virtual space, on condition that the selection of the game title to play is accepted, and the processing related to preparation for a game play includes processing for match-making an opponent for the game play of the game title.

(2) In the program described in (1), two or more second virtual spaces are provided, in each of which is associated with one of the game titles, and in the display control processing, the virtual character of the user is placed in the second virtual space associated with the game title to play.

(3) In the program described in (2), the control processing controls the processing related to preparation for play so as to be executable for only a game of the game title associated with the second virtual space when the virtual character of the user is placed in the second virtual space.

(4) In the program described in (2) or (3), in the control processing, processing is performed so as to accept a command for movement of the virtual character to the first virtual space when the virtual character of the user is placed in the second virtual space, in the display control processing, the virtual character of the user is relocated to the first virtual space on condition that the command for movement is accepted, and in the control processing, control is performed to accept a selection of a game title to play again.

(5) In the program described in any one of (2)-(4), a maximum number of virtual characters which can be placed in the second virtual space is set in advance, in the control processing, when the virtual character of the user is placed in the first virtual space, control is performed so that a game title associated with the second virtual space is made unselectable as a game title to play where the maximum number of virtual characters are placed in the second virtual space.

(6) In the program described in any one of (2)-(5), in the control processing, control is performed so as to accept a selection of the game title to play on condition that the virtual character is place in a predetermined position of the first virtual space.

(7) In the program described in (6), the predetermined position is a neighborhood of at least one of the wall portion and the window provided in the first virtual space.

(8) In the program described in (7), in the display control processing, the two or more game titles which can be selected as the game title to play are displayed on at least one of the wall portion and window of the first virtual space.

(9) In the program described in (8), in the display control processing, the tow or more game titles which can be selected a the game title to play is displayed when a distance between the wall portion or the window section and the virtual character of the user is a threshold or less, and the two or more game titles are not displayed when the distance is more than the threshold.

(10) In the program described in (8) or (9), in the display control processing, the tow or more game titles which can be selected a the game title to play is displayed when a distance between the wall portion or the window and the virtual character of the user is a threshold or less, and the two or more game titles are not displayed when the distance is more than the threshold.

(11) In the program described in (10), in the control processing, a selection of the game title to play is accepted when one of the icons is selected, on condition that the list of the two or more game titles is displayed as the icons.

(12) In the program described in any one of (8)-(11), in the display control processing, the two or more game titles which can be selected as the game title to play is displayed only during a predetermined period.

(13) In the program described in any one of (8)-(12), in the display control processing, when the virtual character of the user face the wall portion or window section in the first virtual space, the selectable two or more game titles are displayed as the game title to play.

(14) An information processing unit comprises: a display control unit which displays, on a display unit, a virtual space where a virtual character associated with a user is placed so as to be movable; and a control unit which executes processing in response to a request from the user depending on the virtual space in which the virtual character of the user is placed, wherein the virtual space includes a first virtual space and a second virtual space, the control unit performs processing to accept a selection of a game title to play from two or more game titles by the user when the virtual character of the user is placed in the first virtual space, and performs processing related to preparation for play of a game of the game title to play when the virtual character of the user is placed in the second virtual space, the display control unit displays, on the display unit the virtual character of the user placed in the first virtual space so as to be placed in the second virtual space, on condition that the selection of the game title to play is accepted, and the processing related to preparation for play includes processing for match-making an opponent for the game of the game title to play.

(15) A match-making server comprises: a display control unit which displays, on an information processing unit, a virtual space where a virtual character associated with a user is placed so as to be movable; and a control unit which executes processing in response to a request from the user according to the virtual space in which the virtual character of the user is placed, wherein the virtual space includes a first virtual space and a second virtual space, the control unit performs processing to accept a selection of a game title to play from two or more game titles by the user when the virtual character of the user is placed in the first virtual space, and performs processing related to preparation for play of a game of the game title to play when the virtual character of the user is placed in the second virtual space, the display control unit displays the virtual character of the user placed in the first virtual space so as to be arranged in the second virtual space, on condition that the selection of the game title to play is accepted, and the processing related to preparation for play includes processing for match-making an opponent for the game of the game title to play.

(16) A match-making system comprising: a display control unit which displays, on a display unit of an information processing unit, a virtual space where a virtual character associated with a user is placed so as to be movable; and a control unit which executes processing in response to a request from the user depending on the virtual space in which the virtual character of the user is placed, wherein the virtual space includes a first virtual space and a second virtual space, the control unit performs processing to accept a selection of a game title to play from two or more game titles by the user when the virtual character of the user is placed in the first virtual space, and performs processing related to preparation for play of a game of the game title to play when the virtual character of the user is placed in the second virtual space, the display control unit displays the virtual character of the user placed in the first virtual space so as to be arranged in the second virtual space, on condition that the selection of the game title to play is accepted, and the processing related to preparation for play includes processing for match-making an opponent for the game of the game title to play.

### Another Embodiment

The present invention is not limited to the above-described embodiments, various modifications and/or changes thereof may be made within the subject matter of the present invention.

1. A program causing a computer to execute:
a display control process which displays a virtual space where a virtual character associated with a user is placed so as to be movable; and
a control process which executes process in response to a request from the user depending on the virtual space in which the virtual character of the user is placed,
wherein the virtual space includes a first virtual space and a second virtual space,
in the control process,
process is performed to accept a selection of a game title to play from two or more game titles by the user when the virtual character of the user is arranged in the first virtual space,
process related to preparation for play of a game of the game title to play is performed when the virtual character of the user is placed in the second virtual space
in the display control process,
the virtual character of the user placed in the first virtual space is arranged in the second virtual space, on condition that the selection of the game title to play is accepted, and
the process related to preparation for play includes process for match-making an opponent for the game of the game title to play.

2. The program according to claim 1, wherein two or more second virtual spaces are provided, in each of which is associated with one of the game titles, and in the display control process, the virtual character of the user is placed in the second virtual space associated with the game title to play.

3. The program according to claim 2, wherein the control process controls the process related to preparation for play so as to be executable for only a game of the game title associated with the second virtual space when the virtual character of the user is placed in the second virtual space.

4. The program according to claim 2, wherein in the control process, a process is performed so as to accept a command for transfer of the virtual character to the first virtual space when the virtual character of the user is placed in the second virtual space,
in the display control process, the virtual character of the user is relocated to the first virtual space on condition that the command for transfer is accepted, and
in the control process, control is performed to accept a selection of a game title to play again.

5. The program according to claim 2, wherein a maximum number of virtual characters which can be placed in the second virtual space is set in advance,
in the control process, when the virtual character of the user is placed in the first virtual space, control is performed so that a game title associated with the second virtual space is made unselectable as a game title to play where the maximum number of virtual characters are placed in the second virtual space.

6. The program according to claim 2, wherein in the control process, control is performed so as to accept a selection of the game title to play on condition that the virtual character is place in a predetermined position of the first virtual space.

7. The program according to claim 6, wherein the predetermined position is a neighborhood of at least one of the wall portion and the window section provided in the first virtual space.

8. The program according to claim 7, wherein in the display control process, the two or more game titles which can be selected as the game title to play are displayed on at least one of the wall portion and window section of the first virtual space.

9. The program according to claim 8, wherein in the display control process, the tow or more game titles which can be selected a the game title to play is displayed when a distance between the wall portion or the window and the virtual character of the user is a threshold or less, and the two or more game titles are not displayed when the distance is more than the threshold.

10. The program according to claim 8, wherein in the display control, a list of the two or more game titles are displayed as icons.

11. The program according to claim 10, wherein in the control process, a selection of the game title to play is accepted when one of the icons is selected, on condition that the list of the two or more game titles is displayed as the icons.

12. The program according to claim 8, wherein in the display control process, the two or more game titles which can be selected as the game title to play is displayed only during a predetermined period.

13. The program according to claim 8, wherein in the display control process, when the virtual character of the user face the wall portion or window in the first virtual space, the selectable two or more game titles are displayed as the game title to play.

14. An information process unit comprising:
a display control unit which displays, on a display unit, a virtual space where a virtual character associated with a user is placed so as to be movable; and
a control unit which executes process in response to a request from the user depending on the virtual space in which the virtual character of the user is placed,
wherein the virtual space includes a first virtual space and a second virtual space,
the control unit performs process to accept a selection of a game title to play from two or more game titles by the user when the virtual character of the user is placed in the first virtual space, and performs process related to preparation for play of a game of the game title to play when the virtual character of the user is placed in the second virtual space,
the display control unit displays, on the display unit the virtual character of the user placed in the first virtual space so as to be placed in the second virtual space, on condition that the selection of the game title to play is accepted, and
the process related to preparation for play includes process for match-making an opponent for the game of the game title to play.

15. A match-making server comprising:
a display control unit which displays, on an information process unit, a virtual space where a virtual character associated with a user is placed so as to be movable; and
a control unit which executes process in response to a request from the user according to the virtual space in which the virtual character of the user is placed,
wherein the virtual space includes a first virtual space and a second virtual space,
the control unit performs process to accept a selection of a game title to play from two or more game titles by the user when the virtual character of the user is placed in the first virtual space, and performs process related to preparation for play of a game of the game title to play when the virtual character of the user is placed in the second virtual space,
the display control unit displays the virtual character of the user placed in the first virtual space so as to be arranged in the second virtual space, on condition that the selection of the game title to play is accepted, and
the process related to preparation for play includes process for match-making an opponent for the game of the game title to play.

16. A match-making system comprising:
a display control unit which displays, on a display unit of an information process unit, a virtual space where a virtual character associated with a user is placed so as to be movable; and
a control unit which executes process in response to a request from the user depending on the virtual space in which the virtual character of the user is placed,
wherein the virtual space includes a first virtual space and a second virtual space,
the control unit performs process to accept a selection of a game title to play from two or more game titles by the user when the virtual character of the user is placed in the first virtual space, and performs process related to preparation for play of a game of the game title to play when the virtual character of the user is placed in the second virtual space,
the display control unit displays the virtual character of the user placed in the first virtual space so as to be arranged in the second virtual space, on condition that the selection of the game title to play is accepted, and
the process related to preparation for play includes process for match-making an opponent for the game of the game title to play.
